(19) United States
(12) Patent Application Publication
(10) Pub. No.: US 2011/0254228 A1
(43) Pub. Date: Oct. 20, 2011

(54) Thermal Chamber

(75) Inventors: Arthur W. Custer, III, Ventura, CA (US); Henry J. Poole, Ventura, CA (US); Mark R. Erickson, Newbury Park, CA (US); Nader Jamshidi, Newbury Park, CA (US); Aaron L. Dingus, Moorpark, CA (US)

(73) Assignee: POOLE VENTURA, INC., Oxnard, CA (US)

(21) Appl. No.: 13/016,595

(22) Filed: Jan. 28, 2011

(51) Int. Cl. F16J 15/02

(52) U.S. Cl. 277/312; 277/630; 277/317

(57) ABSTRACT

A process chamber that provides an interior surface and an exterior surface is confined within a containment chamber. Secured to the containment chamber is a collar that communicates with the process chamber. A seal formed between the process chamber and the collar, includes at least an adjustable backing ring encircling the exterior surface of the process chamber, a preload ring secured to the collar, and a sealing structure encircling the process chamber and positioned between the adjustable backing ring and the preload ring. The adjustable backing ring is adjustably secured a predetermined distance from the preload ring, based on a perimeter dimension of the process chamber, to form the seal between the process chamber and the collar.

### FIELD OF THE INVENTION

The claimed invention relates to the field of thermal diffusion chamber equipment and methods of making thermal diffusion chambers for the production of solar energy panels, and more particularly to structures and methods of sealing an internal environment of a process chamber of the thermal diffusion chamber from an external environment of the process chamber.

### BACKGROUND

A form of solar energy production relies on solar panels, which in turn rely on the deposition of select materials onto a substrate. In one example glass is used as the substrate, which is exposed to a gaseous selenide species to form a copper, indium and selenide containing film on the substrate. The gaseous selenide species is known to be toxic to humans, which underscores prudent handling methods, including seal systems.

As such, a seal system capable of precluding migration and leakage of the gaseous selenide species from within a process chamber to a containment chamber, in an efficient and reliable manner, can greatly improve the operation and production of thermal chambers used in providing substrates a copper, indium and selenide containing film deposited thereon.

Accordingly, there is a continuing need for improved mechanisms and methods of forming seals an internal environment of the process chamber from the exterior environment of the process chamber.

### SUMMARY OF THE INVENTION

The present disclosure relates to thermal chambers, and in particular to sealing systems and methods of sealing the internal environment of the process chamber of the thermal chamber equipment from an external environment of the process chamber

In accordance with various exemplary embodiments, a process chamber that includes at least an interior surface and an exterior surface is confined within a containment chamber. In an exemplary embodiment, secured to the containment chamber is a collar that communicates with the process chamber. Preferably a seal is formed between the process chamber and the collar. In an exemplary embodiment, the seal formed between the process chamber and the collar includes at least an adjustable backing ring encircling the exterior surface of the process chamber, a preload ring secured to the collar, and a sealing structure encircling the process chamber and disposed between the adjustable backing ring and the preload ring. Preferably, to form the seal between the process chamber and the collar, the adjustable backing ring is adjustably secured a predetermined distance from the preload ring, based on a perimeter dimension of the process chamber.

In an alternate exemplary embodiment, a thermal chamber is formed by providing a containment chamber, confining a process chamber within the containment chamber, wherein the process chamber provides at least an interior surface and an exterior surface. Preferably, additional steps include securing a collar to the containment chamber, the collar communicating with the process chamber, and forming a seal between the process chamber and the collar. In a preferred exemplary embodiment the seal formed between the process chamber and the collar includes at least an adjustable backing ring encircling the exterior surface, a preload ring secured to the collar, and a sealing structure encircling the process chamber and disposed between the adjustable backing ring and the preload ring, in which the adjustable backing ring is adjustably secured a predetermined distance from the preload ring based on a perimeter dimension of the process chamber to form the seal between the process chamber and the collar.

These and various other features and advantages that characterize the claimed invention will be apparent upon reading the following detailed description and upon review of the associated drawings.

### BRIEF DESCRIPTION OF THE DRAWINGS

FIG. 1 displays an orthogonal projection of an exemplary embodiment of a thermal chamber of the claimed invention.

FIG. 2 provides an orthogonal projection of an exemplary substrate support frame configured for use with the exemplary embodiment of the thermal chamber of FIG. 1.

FIG. 3 shows a partial cross-sectional, upper side elevation view of the exemplary embodiment of the thermal chamber of FIG. 1.

FIG. 4 illustrates a partial cross-sectional, lower side elevation view of the exemplary embodiment of the thermal chamber of FIG. 1.

FIG. 5 provides a detailed partial cross-sectional, upper side elevation view of the exemplary embodiment of the thermal chamber of FIG. 1.

FIG. 6 displays an enlarged detailed partial cross-sectional, upper side elevation view of the exemplary embodiment of the thermal chamber of FIG. 1.

FIG. 7 shows a detailed partial cross-sectional, upper front side orthogonal projection of the exemplary embodiment of the thermal chamber of FIG. 1.

FIG. 8 generally illustrates a flow chart of a method of forming an exemplary embodiment of the thermal chamber of FIG. 1.

### DETAILED DESCRIPTION OF AN EXEMPLARY EMBODIMENT OF THE DRAWINGS

Reference will now be made in detail to one or more examples of various embodiments of the present invention depicted in the figures. Each example is provided by way of explanation of the various embodiments of the present invention, and not meant as a limitation of the invention. For example, features illustrated or described as part of one embodiment may be used with another embodiment to yield still a different embodiment. Other modifications and variations to the described embodiments are also contemplated within the scope and spirit of the claimed invention.

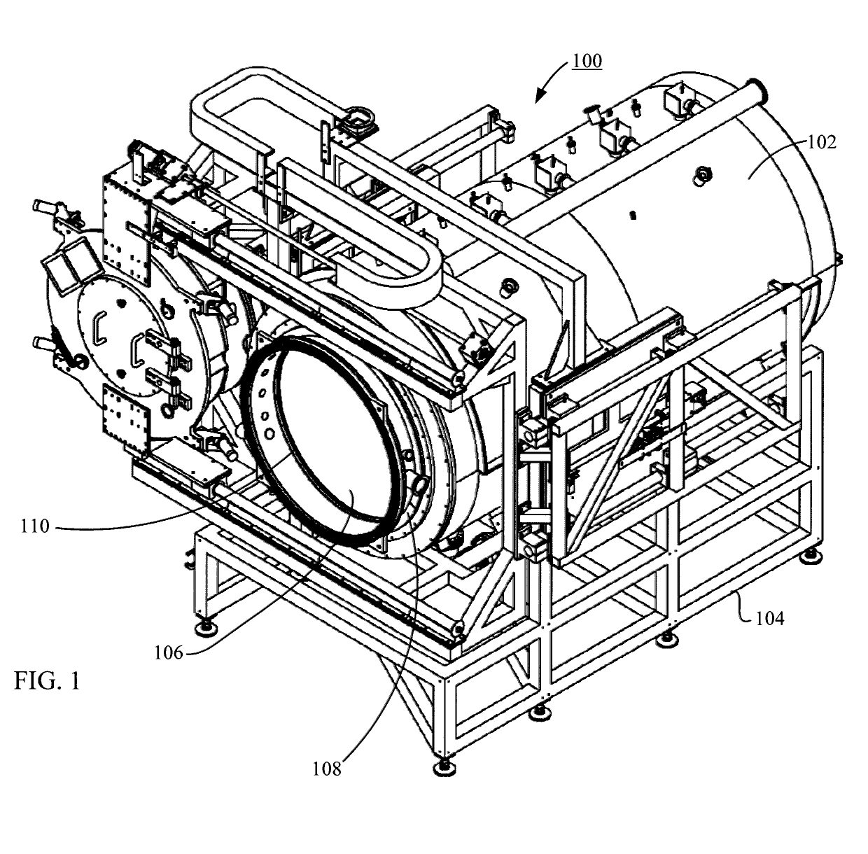

Turning to the drawings, FIG. 1 displays an exemplary thermal chamber 100 which includes at least a containment chamber 102 supported by a frame 104, and in turn supporting a process chamber 106. Preferably the exemplary thermal chamber 100 further includes a collar 108 in butting adjacency with the process chamber 106 and secured to the containment chamber 102, and a seal 110 formed between the process chamber 106 and the collar 108.

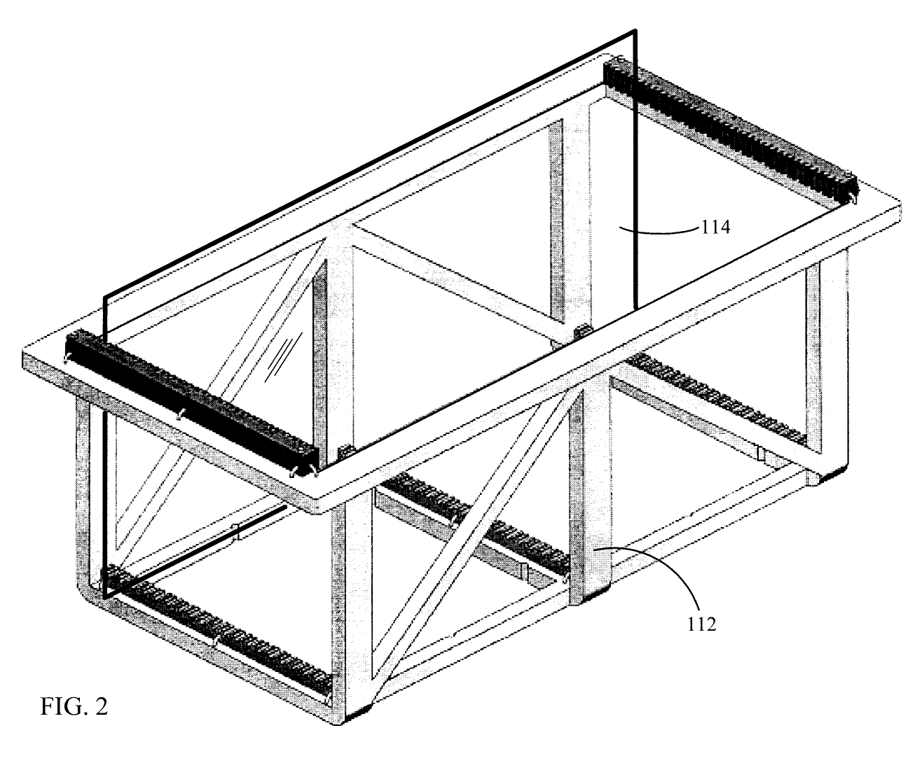

FIG. 2 shows exemplary substrate support frame 112 configured for use with the exemplary embodiment of the thermal chamber 100 (of FIG. 1). In a preferred embodiment, the substrate support frame 112 is formed from quarts and accommodates a plurality of substrates 114 (one shown). In operation, the substrate support frame 112 is filled to capacity with substrates 114 and positioned within the process chamber 106. Within the process chamber 106, the substrate support frame 112, serves as a fixture for the substrates 114 during the deposition process. Preferably the substrates 114 are rectangular in shape having a width of substantially 650 millimeters and a length of substantially 1650 millimeters, and are formed from glass, preferably soda-lime-silica glass.

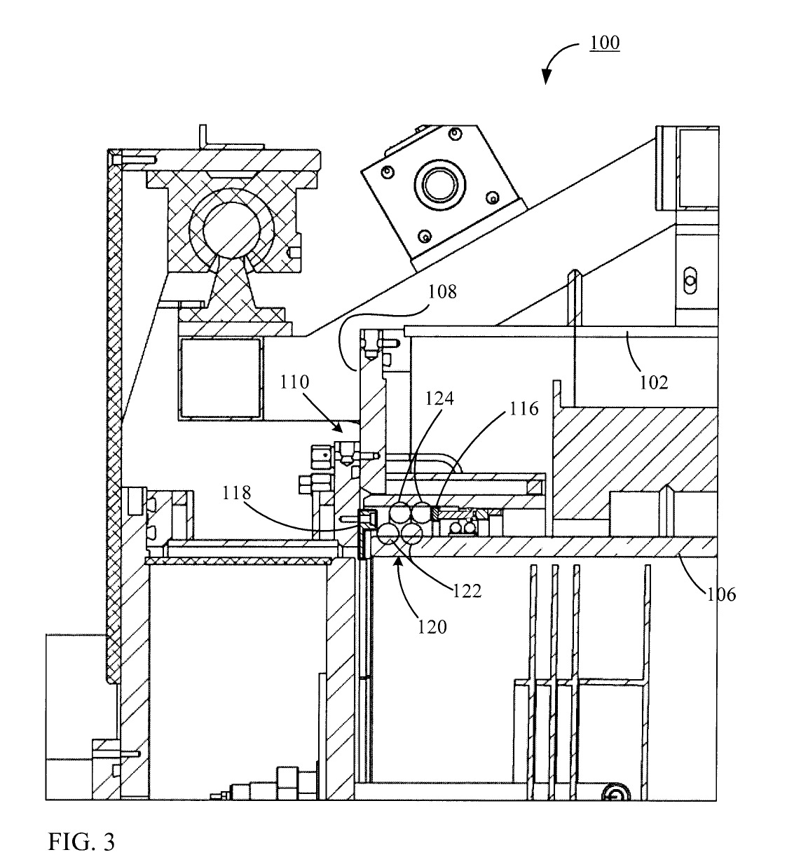

The cross-sectional, upper front view of the thermal chamber 100 shown by FIG. 3 provides a more detailed depiction of the seal 110 formed between the process chamber 106 and the collar 108. Shown therein is an adjustable backing ring 116 and a preload ring 118 with a sealing structure 120 disposed there between. In a preferred embodiment, the sealing structure 120 includes a compliant member (122, 124), which preferably includes a first pair of o-rings 122, and a second pair of o-rings 124. Preferably, each of the first pair of o-rings 122 features in inner circumference slightly less than a perimeter dimension of the process chamber 106, to provide a snug but slidable fit of each of the first pair of o-rings 122 over the external perimeter of the process chamber 106. Each of the second pair of o-rings 124 feature an inner circumference less than an outer circumference of the first pair of o-rings 122, but greater than the external perimeter of the process chamber 106, to assure an inability of each of the second pair of o-rings 124 to slip under either of the first pair of o-rings 122 during installation. It will be noted that the first pair of o-rings 122 and the second pair of o-rings 124 are depicted in their non-compressed form to convey that the o-rings 122 and 124 undergo about a thirty percent (30%) compression when forming the seal 110.

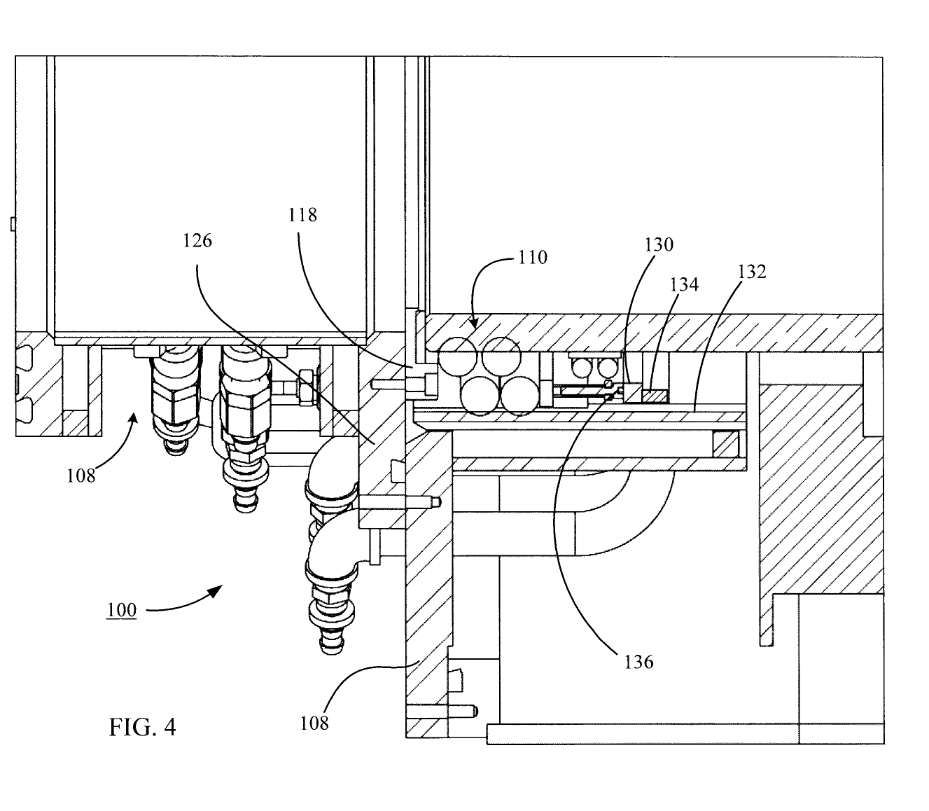

FIG. 4 shows the seal 110 preferably further includes a pre-load ring support 126 attached to the preload ring 118. FIG. 4 still further shows that the seal 110 formed between the process chamber 106 and the collar 108 further includes a backing ring support structure 130 in contacting adjacency with a seal structure confinement member 132 of the collar 108, and a weldment 134 secured to the seal structure confinement member 132. The backing ring support structure 130 provides an adjustment assembly alignment feature 136 to aid in controlling the position of the adjustable backing ring 116 relative to the preload ring 118, while the weldment 134 provides a datum from which to locate the adjustable backing ring 116 relative to the preload ring 118.

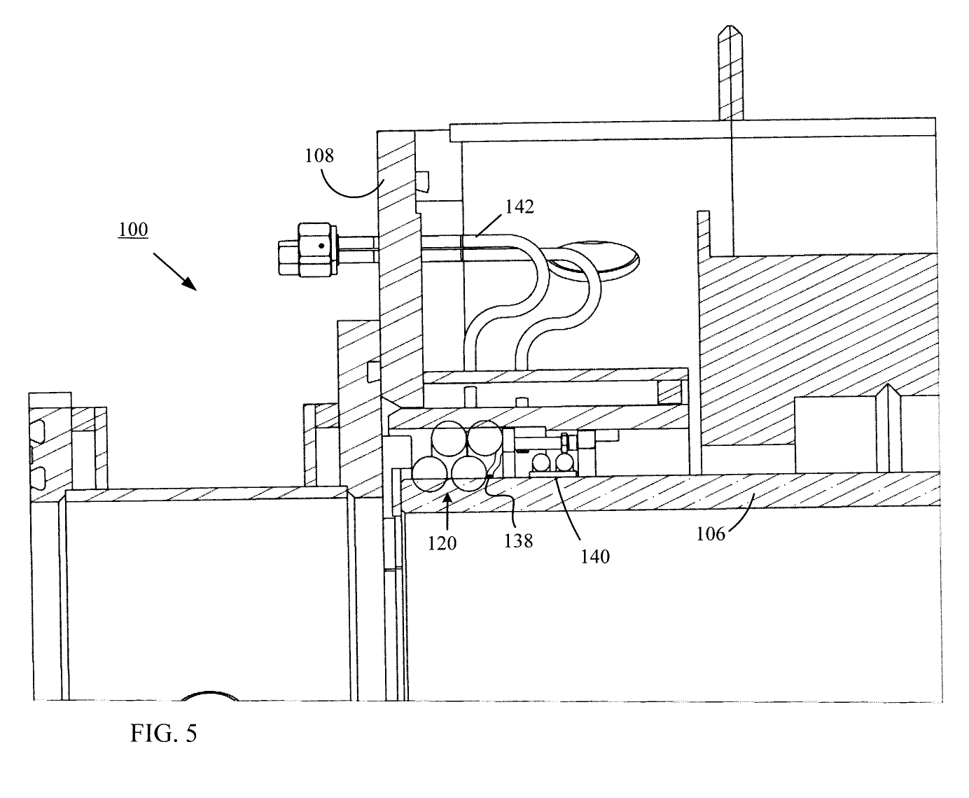

As shown by FIG. 5, the seal 110 formed between the process chamber 106 and the collar 108 preferably further includes a thermal monitoring device 138, such as a thermocouple, disposed between the sealing structure 120 and the process chamber 106. The thermal monitoring device 138 monitors the temperature of the sealing structure 120, and when the temperature of the sealing structure 120 achieves a predetermined level, a cooling assembly 140 is activated to reduce the temperature of the process chamber 106 in a region adjacent in the sealing structure 120, which in turn reduces the temperature of the sealing structure 120. In a preferred embodiment, the cooling assembly 140 includes a plurality of coils encircling the exterior surface of the process chamber 106 through which chilled water is supplied. The coils are preferably secured to the process chamber 106 via a thermal conductive adhesive.

FIG. 5 further shows the seal 110 formed between the process chamber 106 and the collar 108 additionally preferably includes a differential vacuum conduit 142 adjacent the sealing structure 120 and extending through the collar 108. In a preferred embodiment, the differential vacuum conduit 142 providing means for checking integrity of the seal 110 formed between the process chamber 106 and the collar 108, and preferably aids in establishing the seal 110 formed between the process chamber 106 and the collar 108 when the preload ring 118 is being positioned in its final location by drawing a vacuum on the sealing structure 120 while the preload ring 118 is being finally positioned.

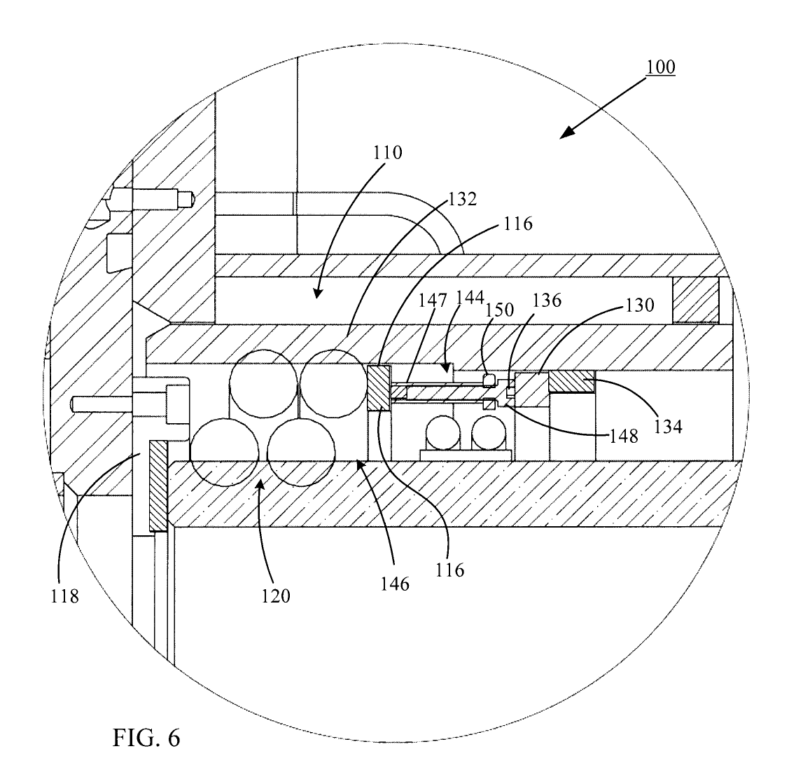

FIG. 6 shows in a preferred embodiment, an adjustment assembly 144 is disposed between the backing ring support structure 130 and the adjustable backing ring 116. The adjustment assembly 144 preferably controls a predetermined distance between the preload ring 118 and the adjustable backing ring 116. The predetermined distance is preferably determined by first determining a volume of a seal cavity 146. In a preferred embodiment, the seal cavity 146 is bounded by the seal structure confinement member 132, the adjustable backing ring 116, the preload ring 118, and the exterior surface of the process chamber 106. The volume of the seal cavity can be determined by calculating the cross-sectional area of the seal cavity 146, and integrating the calculated area around the circumference of the seal cavity 146.

Based on the volume of the seal cavity 146, the preferred particular configuration of the sealing structure 120 can be determined, along with the desired compressed volume of that preferred particular configuration of the sealing structure 120. Knowing the final preferred compressed volume of the particular configuration of the sealing structure 120, a calculation is made to determine the desired distance between the adjustable backing ring 116 and the preload ring 118 to achieve the preferred volume of the seal cavity 146 that correlates with the final preferred compressed volume of the particular configuration of the sealing structure 120. Once that distance is determined, the adjustment assembly 144 is manipulated to achieve the desired distance between the preload ring 118 and the adjustable backing ring 116. In a preferred embodiment, a plurality of adjustment assemblies 144 are distributed around the adjustable backing ring 116 to assure the adjustable backing ring 116 remains square with the weldment 134.

Continuing with FIG. 6, in a preferred embodiment, the adjustment assembly 144 includes a hollow core push shaft 147 attached to the adjustable backing ring 116 on a first end, a threaded rod 148 linked to the backing ring support structure 130 and protruding into the hollow core of the hollow core push shaft 147, and a fastener 150 engaging the threaded rod and disposed between the second end of the hollow core push shaft 147 and the backing ring support structure 130. In a preferred embodiment, activation of the fastener 150 in a first direction of rotation causes the fastener 150 to advance in a direction toward the preload ring 118, which results in decreasing the volume of the seal cavity 146. Activation of the fastener 150 in a second direction of rotation, opposite from the first direction of rotation, causes the fastener 150 to retreat in a direction away from the preload ring 118, which results in increasing the volume of the seal cavity 146. Accordingly, in a preferred embodiment, the predetermined distance between the adjustable backing ring 116 and the preload ring 118 is determined by the final preferred compressed volume of the particular configuration of the seal structure 120.

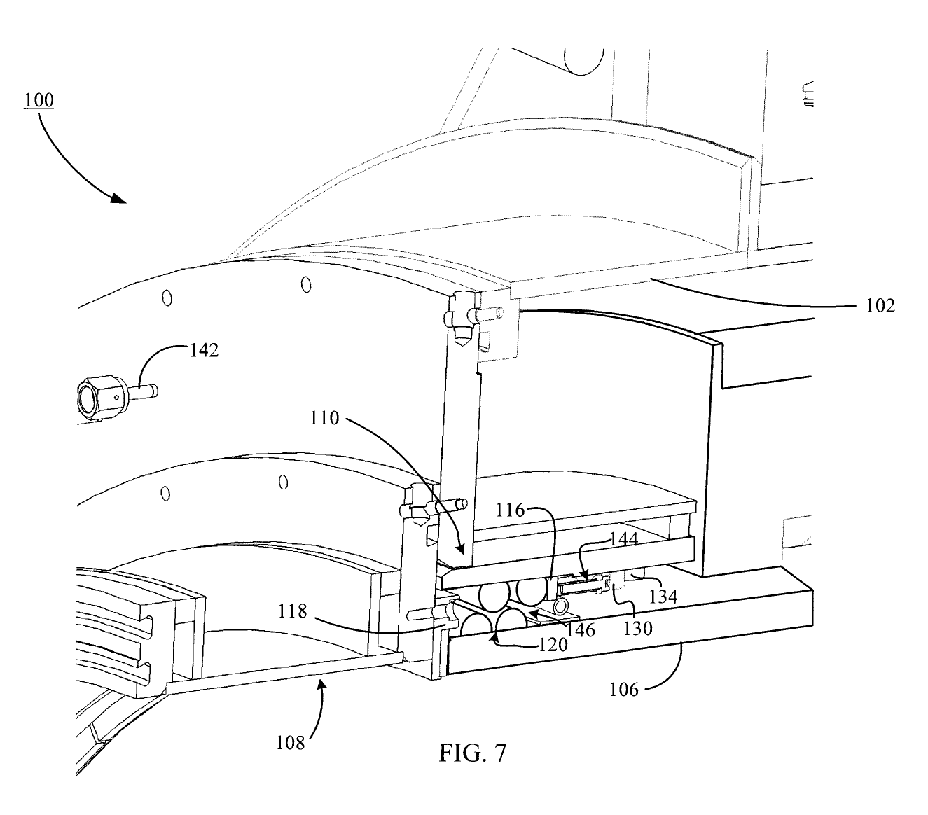

FIG. 7 provides a spatial relationship between the components of the preferred thermal chamber 100 of FIG. 1. Shown therein is the spatial relationship between the containment chamber 112, the process chamber 106, the collar 108, and the seal 110 formed between the process chamber 106 and the containment chamber 102.

FIG. 7 further shows the spatial relationship between the components of the preferred seal 110 formed between the process chamber 106 and the containment chamber 102 that include the adjustable backing ring 116 offset from the preload ring 118, which in combination with the seal structure confinement member 132 and the process chamber 106, form the seal cavity 146.

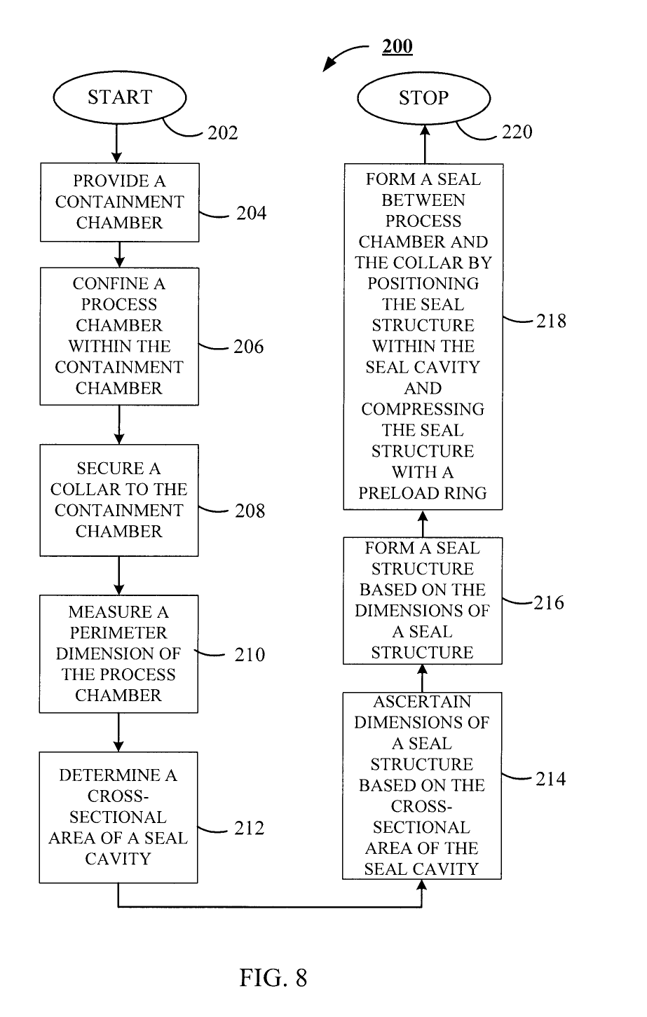

FIG. 8 provides an exemplary method of making a thermal chamber 200 conducted in accordance with various embodiments of the present invention. The method of making a thermal chamber 200 commences at start step 202 and continues with process step 204. At process step 204 a containment chamber (such as 102) is provided. At process step 206, a process chamber (such as 106) is confined within the containment chamber. Preferably, the process chamber includes at least an interior surface and an exterior surface.

At process step 208, a collar (such as 108) is secured to the containment chamber, is such that the collar communicates with the process chamber. At process step 210, a parameter distance around the exterior of the process chamber is measured and recorded for use in determining a cross-sectional area of a seal cavity (such as 146) at process step 212. In a preferred embodiment the seal cavity is bounded by a seal structure confinement member (such as 132), an adjustable backing ring (such as 116), and a preload ring (such as 118).

At process step 214, dimensions of a seal structure (such as 120) are ascertained based on across-sectional area of steel cavity. Preferably, the ascertained dimensions of the seal structure are used to form the seal structure at process step 216. At process step 218, a seal (such as 110) is formed between the process chamber in the collar by positioning the seal structure within the seal cavity, and compressing the steel structure with a preload ring (such as 118), and the process concludes at stop process step 220.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present claimed invention to the full extent indicated by the broad general meaning of the terms in which the appended claims are expressed. For example, the particular elements may vary depending on the particular application without departing from the spirit and scope of the present claimed invention.

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed by the appended claims.

What is claimed is:

1. A thermal chamber comprising:
a containment chamber;
a process chamber confined within the containment chamber, the process chamber having an interior surface and an exterior surface;
a collar communicating with the process chamber and secured to the containment chamber; and
a seal formed between the process chamber and the collar, the seal formed between the process chamber and the collar comprising:
an adjustable backing ring encircling the exterior surface;
a preload ring secured to the collar; and
a sealing structure encircling the process chamber and disposed between the adjustable backing ring and the preload ring, in which the adjustable backing ring is adjustably secured a predetermined distance from the preload ring, based on a perimeter dimension of the process chamber, to form the seal between the process chamber and the collar.

2. The thermal chamber of claim 1, in which the seal formed between the process chamber and the collar further comprising a preload ring support attached to the preload ring.

3. The thermal chamber of claim 2, in which the seal formed between the process chamber and the collar further comprising an intermediate collar securing the preload ring support to the collar.

4. The thermal chamber of claim 3, in which the seal formed between the process chamber and the collar further comprising a backing ring support structure secured to the collar and cooperating with the adjustable backing ring to maintain the adjustable backing ring the predetermined distance from the preload ring.

5. The thermal chamber of claim 4, in which the seal formed between the process chamber and the collar further comprising a thermal monitoring device disposed between the sealing structure and the process chamber, the thermal monitoring device monitoring the temperature of the sealing structure.

6. The thermal chamber of claim 5, in which the seal formed between the process chamber and the collar further comprising an adjustment assembly disposed between the backing ring support structure and the adjustable backing ring, the adjustment assembly controlling the predetermined distance between the preload ring and the adjustable backing ring.

7. The thermal chamber of claim 6, in which the seal formed between the process chamber and the collar further comprising a differential vacuum conduit adjacent the sealing structure and extending through the collar, the vacuum conduit providing means for checking integrity of the seal formed between the process chamber and the collar.

8. The thermal chamber of claim 7, in which the sealing structure comprising a compliant member.

9. The thermal chamber of claim 1, in which the seal formed between the process chamber and the collar further comprising a thermal monitoring device disposed between the sealing structure and the process chamber, the thermal monitoring device to monitor the temperature of the sealing structure.

10. The thermal chamber of claim 1, in which the seal formed between the process chamber and the collar further comprising a differential vacuum conduit adjacent the sealing structure and extending through the collar, the vacuum conduit providing means for checking integrity of the seal formed between the process chamber and the collar.

11. The thermal chamber of claim 1, in which the seal formed between the process chamber and the collar further comprising a backing ring support structure secured to the collar and cooperating with the adjustable backing ring to maintain the adjustable backing ring the predetermined distance from the preload ring.

12. The thermal chamber of claim 11, in which the seal formed between the process chamber and the collar further comprising an adjustment assembly disposed between the backing ring support structure and the adjustable backing ring, the adjustment assembly controlling the predetermined distance between the preload ring and the adjustable backing ring.

13. A method of forming a thermal chamber by steps comprising:
providing a containment chamber;
confining a process chamber within the containment chamber, the process chamber having an interior surface and an exterior surface;
securing a collar to the containment chamber, the collar communicating with the process chamber; and
forming a seal between the process chamber and the collar, the seal between the process chamber and the collar comprising:
an adjustable backing ring encircling the exterior surface;
a preload ring secured to the collar; and
a sealing structure encircling the process chamber and disposed between the adjustable backing ring and the preload ring, in which the adjustable backing ring is adjustably secured a predetermined distance from the preload ring based on a perimeter dimension of the process chamber to form the seal between the process chamber and the collar.

14. The method of claim 13, in which the collar includes at least a seal structure confinement member, and further in which forming the seal between the process chamber and the collar by steps further comprising:
measuring a perimeter dimension of the process chamber; and
determining a cross-sectional area of a seal cavity based on the perimeter dimension of the process chamber, wherein the seal cavity is bounded by the seal structure confinement member, the adjustable backing ring, the preload ring, and the exterior surface of the process chamber.

15. The method of claim 14, in which forming the seal between the process chamber and the collar by steps further comprising:
ascertaining dimensions of the seal structure based on the determined cross-sectional area of the seal cavity; and
forming the seal structure based on the dimensions of the process chamber.

16. The method of claim 15, in which forming the seal between the process chamber and the collar by steps further comprising:
calculating the predetermined distance between the preload ring and the adjustable backing ring based on the dimensions of the formed seal structure and the determined cross-sectional area of the seal cavity; and
adjusting the adjustable backing ring to attain the calculated predetermined distance between the preload ring and the adjustable backing ring.

17. The method of claim 13, in which the seal formed between the process chamber and the collar further comprising a preload ring support attached to the preload ring.

18. The method of claim 13, in which the seal formed between the process chamber and the collar further comprising a thermal monitoring device disposed between the sealing structure and the process chamber, the thermal monitoring device to monitor the temperature of the sealing structure.

19. The method of claim 13, in which the seal formed between the process chamber and the collar further comprising a differential vacuum conduit adjacent the sealing structure and extending through the collar, the vacuum conduit providing means for checking integrity of the seal formed between the process chamber and the collar.

20. The method of claim 13, in which the seal formed between the process chamber and the collar further comprising a backing ring support structure secured to the collar and cooperating with the adjustable backing ring to maintain the adjustable backing ring the predetermined distance from the preload ring.
